(19) United States
(12) Patent Application Publication
(10) Pub. No.: US 2016/0053676 A1
(43) Pub. Date: Feb. 25, 2016

(54) ASYMMETRIC TURBOCHARGER WITH VALVE ASSEMBLY

(71) Applicant: Caterpillar Inc., Peoria, IL (US)

(72) Inventors: Xinyu Ge, Peoria, IL (US); Samantha E. Meader, Peoria, IL (US)

(73) Assignee: Caterpillar Inc., Peoria, IL (US)

(21) Appl. No.: 14/929,445

(22) Filed: Nov. 2, 2015

(51) Int. Cl. F02B 37/22; F02B 33/40

(52) U.S. Cl. CPC F02B 37/22; F02B 33/40

(57) ABSTRACT

An asymmetric turbocharger of the present disclosure includes a turbine adapted to receive exhaust gas from an engine. The turbine includes a first volute, a second volute, and a valve assembly. The valve assembly includes a diaphragm to define a first chamber and a second chamber. The first chamber is adapted to receive compressed gas from the compressor and the second chamber is in fluid communication with the first volute. The valve assembly also includes a valve member disposed in the second chamber to cover an aperture of the second volute, against a force of a spring. The valve member is displaced when pressure of exhaust gas in the second volute is greater than a combined force of pressure of the compressed gas and the force of the spring. The exhaust gas enters the second chamber from the second volute to mix with the exhaust gas of the first volute.

### TECHNICAL FIELD

The present disclosure relates to an engine and more particularly to a turbocharger assembly in the engine.

### BACKGROUND

Typically, a turbocharger is disposed in fluid communication with an exhaust manifold of the internal combustion engine, hereinafter referred to as the engine, to extract power from exhaust gas. The turbocharger includes a turbine part and a compressor part. In order to maximize power output, the engine is often equipped with a divided exhaust manifold, which is in fluid communication with an inlet of the turbine part. The divided exhaust manifold increases engine power by helping to preserve exhaust pulse energy generated by the engine's combustion chambers. Preserving the exhaust pulse energy improves turbocharger operation, which results in a more efficient use of fuel.

In addition, to improve fuel efficiency, the exhaust gas from the divided exhaust manifold is recirculated to the engine and such a process is referred to as exhaust gas recirculation (EGR). These EGR systems often require a certain level of backpressure to force a desired amount of exhaust gas back to the engine. For the purpose of developing the backpressure in the divided exhaust manifold, an asymmetric turbocharger is employed. Each volute of the asymmetric turbocharger has a linearly varying cross-section along the length of the volute. In addition, cross-section of one volute is different from the other. However, in order to improve the efficiency of the engine, exhaust gas flowing through the volutes and impinging on blades of the turbine may need to be controlled. Conventionally, the asymmetric turbocharger is equipped with a balance valve to control and allow mixing of the exhaust gas flowing in the volutes.

U.S. Pat. No. 8,196,403 B2, hereinafter referred to as the '403 patent, describes a turbocharger having a balance valve, waste gate, and a common actuator. The turbocharger of the '403 patent includes a turbine housing with a first volute, a second volute, and a common outlet. The turbocharger also has a turbine wheel disposed between the common outlet and the first and second volutes. The turbocharger further includes a first valve configured to selectively fluidly communicate the first volute with the second volute upstream of the turbine wheel, a second valve configured to selectively fluidly communicate the second volute with the common outlet to bypass the turbine wheel, and a common actuator configured to move the first and second valves. The common actuator includes a spring-biased piston member disposed within a pressure chamber and fixedly connected to a piston rod. As such, the common actuator disclosed in the '403 patent is mechanically actuated. However, the common actuator may not decouple the control of balance valve from other valves.

### SUMMARY OF THE DISCLOSURE

According to an aspect of the present disclosure, an asymmetric turbocharger of an engine is described. The asymmetric turbocharger includes a compressor and a turbine. The turbine is coupled to the compressor and is adapted to receive exhaust gas from the engine. The turbine includes a first volute having a first cross-section and a second volute having a second cross-section, where the second cross-section is smaller than the first cross-section. The turbine also includes a valve assembly. The second volute includes an aperture. Further, the valve assembly includes a diaphragm movably disposed within the valve assembly. The diaphragm is coupled to an inner surface of the valve assembly to define a first chamber and a second chamber. The first chamber is in fluid communication with an outlet of the compressor to receive a portion of compressed gas from the compressor, where the portion of the compressed gas is associated with a first pressure. Furthermore, the second chamber is in fluid communication with the exhaust gas flowing in the first volute. The valve assembly further includes a valve member disposed in the second chamber to cover the aperture of the second volute. The valve member rests on the aperture against a force of a spring to restrict entry of exhaust gas of the second volute into the second chamber. Further, the valve member is displaced against the force of the spring, when pressure of the exhaust gas in the second volute is greater than a combined force of the first pressure and the force of the spring. The exhaust gas flowing in the second volute enters the second chamber in the displaced condition of the valve member, to mix with the exhaust gas flowing in the first volute.

Other features and aspects of this disclosure will be apparent from the following description and the accompanying drawings.

### BRIEF DESCRIPTION OF THE DRAWINGS

FIG. 1 is a schematic illustration of an exemplary power system, according to one embodiment of the present disclosure;

FIG. 2 shows a partial sectional view of a turbine of the turbocharger assembly equipped with a valve assembly, according to one embodiment of the present disclosure; and

FIG. 3 shows a cross-section of the valve assembly of FIG. 2, according to one embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

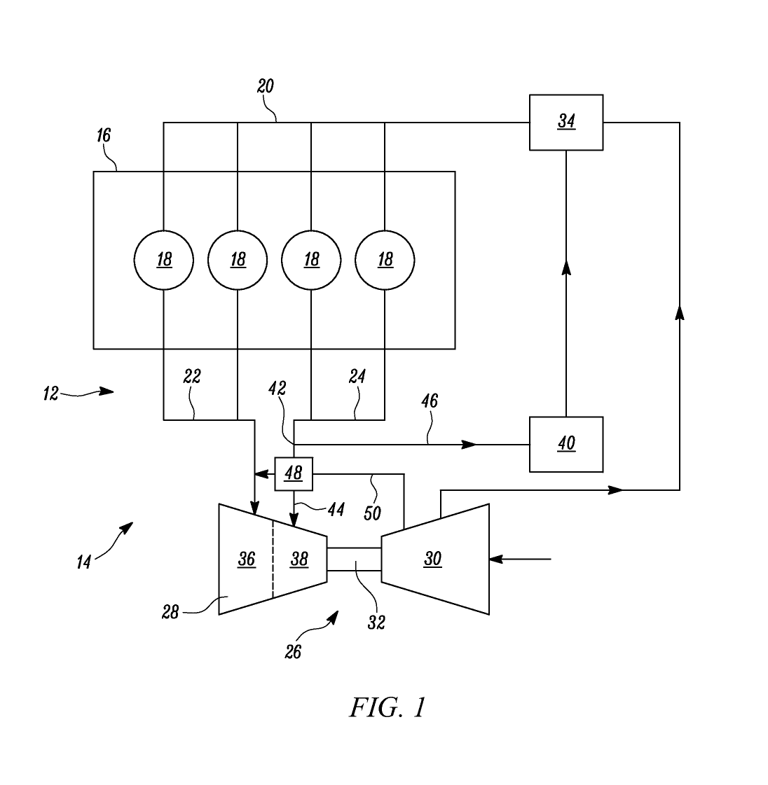

FIG. 1 shows a power system 10 having a power source 12 and an exhaust system 14. For the purposes of this disclosure, power source 12 is depicted and described as a four-stroke diesel engine. However, it will be understood by a person skilled in the art that power source 12 may be any other type of combustion engine such as, for example, a gasoline or a gaseous fuel-powered engine. The power source 12 includes an engine 16. The engine 16 includes a number of cylinders 18, where each cylinder 18 is connected to an inlet manifold 20 for receiving charge, a mixture of fuel and air. In one example, the cylinders 18 may be disposed in an “in-line” configuration, a “V” configuration, or in any other suitable configuration.

Further, the exhaust system 14 includes components configured to direct exhaust gas from the power source 12 to the atmosphere. Specifically, the exhaust system 14 includes a divided exhaust manifold in fluid communication with the cylinders 18. In other words, the exhaust system 14 includes a first exhaust manifold 22 and a second exhaust manifold 24 in fluid communication with the cylinders 18. The exhaust produced during a combustion process within cylinders 18 exits the power source 12 via either the first exhaust manifold 22 or the second exhaust manifold 24.

The exhaust system 14 further includes an asymmetric turbocharger 26 in fluid communication with the divided exhaust manifold. The asymmetric turbocharger 26 includes a turbine 28 operatively coupled to a compressor 30 via a shaft 32. The turbine 28 converts kinetic energy of the exhaust gases into mechanical energy to drive the compressor 30 via the shaft 32. The compressor 30 may be a centrifugal compressor that may include a compressor wheel, a diffuser, and compressor housing. Based on the rotational speed of the compressor wheel, the compressor 30 is adapted to receive air from the atmosphere, compress the received air to high pressure, and thereafter supply the air associated with high pressure to a mixer 34. The air is drawn in an axial direction and expelled in a radial direction. Further, the turbine 28 is driven by the exhaust gases routed from the engine 16 through the divided exhaust manifold. In accordance with an embodiment of the present disclosure, the turbine 28 includes a first volute 36 and a second volute 38 connected to the divided exhaust manifold to receive the exhaust gases from the engine 12. The first exhaust manifold 22 fluidly connects a first set of cylinders 18, for example the first two cylinders 18 from the left, as shown in FIG. 1, to the first volute 36 of the turbine 28. The second exhaust manifold 24 fluidly connects a second set of cylinders 18 of the power source 12, for example the final two combustion chambers from the left, as shown in FIG. 1, to the second volute 38.

The exhaust system 14 further includes an exhaust gas recirculation (EGR) device 40 in fluid communication with the second exhaust manifold 24. The exhaust system 14 includes an inlet port 42 upstream of a passageway 44 connecting the second volute 38 of the turbine 28. The exhaust gas entering the inlet port 42 flows through a passageway 46 to reach the EGR device 40. Thereafter, the exhaust gas is recirculated to the mixer 34 by the EGR device 40. Further, the turbine 28 also includes a valve assembly 48 operably coupled to the second volute 38. The valve assembly 48 is connected to the compressor 30 through a connecting pipe 50.

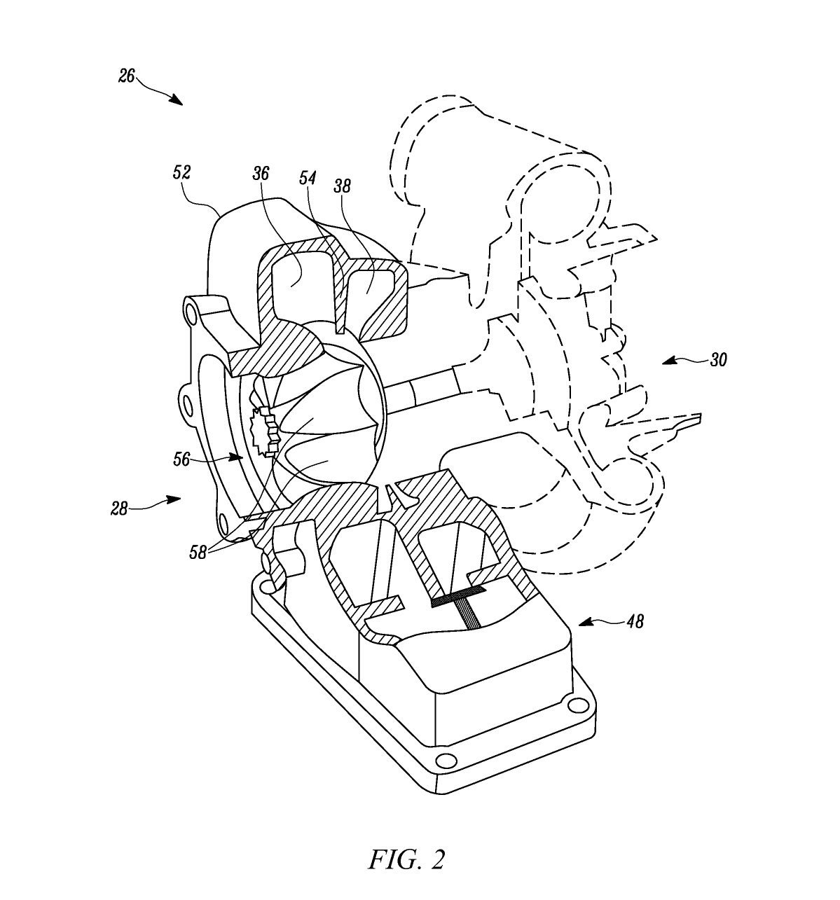

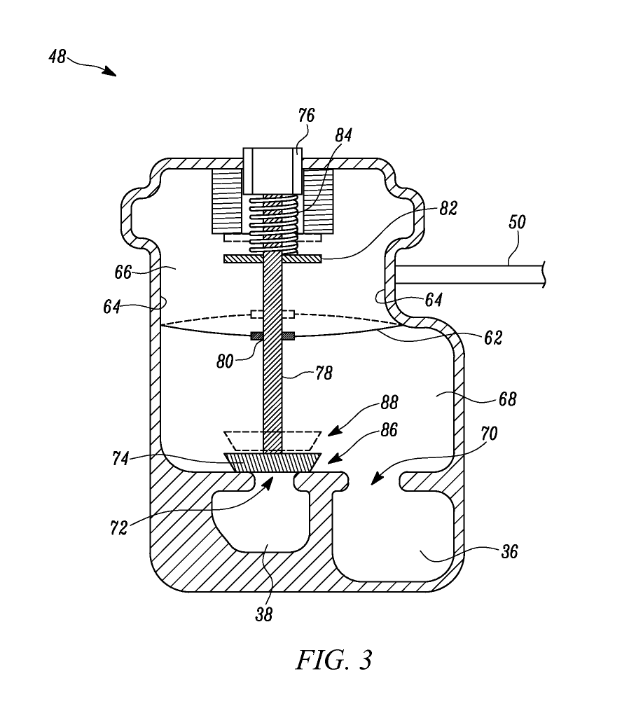

FIG. 2 shows a partial sectional view of the turbine 28 of the asymmetric turbocharger 26 equipped with the valve assembly 48, according to one embodiment of the present disclosure. As described earlier, the turbine 28 is mechanically connected to the compressor 30 via the shaft 32 to form the asymmetric turbocharger 26. The turbine 28 includes a housing 52 defining the first volute 36 and the second volute 38 therein. A wall member 54 divides the first volute 36 from the second volute 38. The first volute 36 has a first cross-section and the second volute 38 has a second cross-section, where the second cross-section is smaller than the first cross-section. The smaller cross-sectional area of the second volute 38 causes a restriction to the flow of exhaust through the second exhaust manifold 24, thereby creating backpressure sufficient to direct at least a portion of the exhaust from second exhaust manifold 24 through the EGR device 40. Further, the housing 52 is adapted to at least partially enclose a turbine wheel 56 therein and direct the exhaust gas to separately impinge on the turbine wheel 56 through the first volute 36 and the second volute 38. As the exhaust gas impinging on blades 58 expand, the turbine wheel 56 rotates and drives the compressor 30. Further, the valve assembly 48, which is described in FIG. 3, is mounted integrally within the turbine 28. The valve assembly 48 includes a valve member 60 at an aperture (not shown) of the second volute 38 of the turbine 28, as shown in FIG. 2.

FIG. 3 shows a cross-section of the valve assembly 48 of FIG. 2. The valve assembly 48 is configured to regulate pressure of the exhaust gas flowing through the second exhaust manifold 24 by selectively allowing the exhaust gas flowing in the second volute 38 to mix with that of the first volute 36. The valve assembly 48 includes a diaphragm 62 movably disposed within the valve assembly 48. The periphery of the diaphragm 62 may be attached to an inner surface 64 of the valve assembly 48 to define a first chamber 66 and a second chamber 68 therein. In other words, the diaphragm 62 divides the volume of the valve assembly 48 into the first chamber 66 and the second chamber 68. In accordance with an aspect of the present disclosure, the first chamber 66 is in fluid communication with an outlet of the compressor 30, via the connecting pipe 50, to receive a portion of compressed gas from the compressor 30. The compressed gas is considered to be associated with a first pressure.

Further, as shown in FIG. 3, the first volute 36 includes an aperture 70 and the second volute 38 includes an aperture 72. Owing to the presence of the aperture 70, the exhaust gas flowing in the first volute 36 is in fluid communication with the second chamber 68. In order to balance the pressure of the exhaust gas flowing in the first volute 36 and the second volute 38, the valve assembly 48 further includes a valve member 74 operably disposed in the second chamber 68 to cover the aperture 72 of the second volute 38. In one example, the valve member 74 may be a poppet valve. The valve member 74 is connected to a hub 76 via a rod member 78. The diaphragm 62 can include an opening for the rod member 78 to pass through and the periphery of the opening is provided with a seal 80 that abuts the surface of the rod member 78. As such, the diaphragm 62 and the seal 80 prevent the compressed gas from mixing with the exhaust gas of the first volute 36.

In addition, a plunger 82 is attached to the rod member 78 at a distance proximal to the hub 76. Further, a spring 84 is coaxially disposed on the rod member 78 between the hub 76 and the plunger 82. A pre-loaded force of the spring 84 can be adjusted by adjusting the position of the hub 76 relative to the plunger 82. With such construction, the valve member 74 is adapted to move from a first position 86 to a second position 88. The valve member 74 rests on the aperture 72 of the second volute 38 against a force of the spring 84 in the first position 86. As such, the valve member 74 covers the aperture 72 and restricts entry of exhaust gas of the second volute 38 into the second chamber 68. Further, the valve member 74 is displaced in a direction towards the hub 76, against the force of the spring 84, in the second position 88.

Various embodiments disclosed herein are to be taken in the illustrative and explanatory sense, and should in no way be construed as limiting of the present disclosure.

### INDUSTRIAL APPLICABILITY

The present disclosure describes the asymmetric turbocharger assembly 26 that houses the valve assembly 48. In a default position, the valve member 74 is biased towards the first position 86 to block the fluid communication between the second volute 38 and the second chamber 68. In operation, when the pressure of the exhaust gas flowing through the second volute 38 is greater than a sum of the first pressure of the compressed gas and the force of the spring 84, the valve member 74 is displaced from the first position 86 to the second position 88. In other words, the exhaust gas flowing in the second volute 38 displaces the valve member 74 to the second position 88 against the force of the spring 84, when the pressure of the exhaust gas is greater than a combined force of the first pressure and the force of the spring 84.

Owing to the displacement of the valve member 74, the aperture 72 of the second volute 38 is opened. Accordingly, the exhaust gas flowing through the second volute 38 enters the second chamber 68 in the displaced condition of the valve member 74. Further, since the second chamber 68 is in fluid communication with the first volute 36, the exhaust gas entering the second chamber 68 from the second volute 38 mixes with the exhaust gas flowing through the first volute 36. Therefore, a pressure differential between the first volute 36 and the second volute 38 may be minimized, thereby minimizing an impact the pressure differential may have on the efficiency of the asymmetric turbocharger 26. In addition, the force with which the exhaust gas impinges on the blades 58 of the turbine wheel 56 is decreased due to the mixing, thereby eliminating high speeds of the turbine 28.

As it would be understood from the above description, the pressure of the exhaust gas aids in displacing the valve member 74, which was otherwise displaced by aid of electrical and electronic devices. Therefore, the valve assembly 48 of the present disclosure minimizes possibility of any failure in the operation of the valve member 74. In addition, the valve assembly 48 of the present disclosure eliminates use of any additional devices for its operation, thereby minimizing any additional costs.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An asymmetric turbocharger of an engine, the asymmetric turbocharger comprising:
a compressor; and
a turbine coupled to the compressor and adapted to receive exhaust gas from the engine, the turbine includes:
a first volute having a first cross-section;
a second volute having a second cross-section, the second cross-section being smaller than the first cross-section, wherein the second volute includes an aperture; and
a valve assembly including:
a diaphragm movably disposed within the valve assembly, the diaphragm coupled to an inner surface of the valve assembly to define a first chamber and a second chamber therein, wherein the first chamber is in fluid communication with an outlet of the compressor to receive a portion of the compressed gas from the compressor, the portion of the compressed gas being associated with a first pressure, and wherein the second chamber is in fluid communication with the exhaust gas flowing in the first volute; and
a valve member operably disposed in the second chamber to cover the aperture of the second volute, the valve member rests on the aperture against a force of a spring to restrict entry of exhaust gas of the second volute into the second chamber, and
wherein the valve member is displaced against the force of the spring, when pressure of the exhaust gas in the second volute is greater than a combined force of the first pressure and the force of the spring, and wherein the exhaust gas flowing in the second volute enters the second chamber in a displaced condition of the valve member, to mix with the exhaust gas flowing in the first volute.
